(19) United States
(12) Patent Application Publication
(10) Pub. No.: US 2026/0265056 A1
(43) Pub. Date: Sep. 10, 2026

(54) HEXAGONAL BORON NITRIDE POWDER, RESIN COMPOSITION, AND RESIN SHEET

(71) Applicant: TOKUYAMA CORPORATION, Yamaguchi (JP)

(72) Inventors: Shota DAIKI, Yamaguchi (JP); Tomoyuki KAKIGI, Yamaguchi (JP)

(21) Appl. No.: 19/167,686

(22) PCT Filed: Feb. 14, 2024
(86) PCT No.: PCT/JP2024/004998

§ 371 Date: Sep. 22, 2025

(30) Foreign Application Priority Data
Mar. 28, 2023 (JP) 2023-052285

(51) Int. Cl. C01B 21/064; C08K 3/38

(52) U.S. Cl. CPC C01B 21/0645; C08K 3/38; C01P 2004/32; C01P 2004/45; C01P 2004/61; C01P 2006/11; C08K 2003/385; C08K 2201/003

(57) ABSTRACT

Achieved is hexagonal boron nitride powder and the like that can exhibit a more favorable thermal conductivity with a smaller filling amount than conventional art. Hexagonal boron nitride powder has a tap bulk density of not less than 0.50 g/cm³ and having an average particle diameter of not less than 15 μm, a ratio of the tap bulk density to a loose bulk density of the hexagonal boron nitride powder being not less than 2.1.

### TECHNICAL FIELD

The present invention relates to hexagonal boron nitride powder, a resin composition, and a resin sheet.

### BACKGROUND ART

Recently, with the miniaturization and advanced power capabilities of electronic components, an increase in an amount of heat generated in electronic components has become a problem. Therefore, in order to efficiently dissipate heat from electronic components, materials having excellent thermal conduction properties have been developed.

Hexagonal boron nitride powder is mixed with resin used for electronic components to improve a thermal conductivity of the resin. Conventional hexagonal boron nitride powder contains primary particles each having a scale-like shape derived from its crystal structure. Such scale-like particles have a thermal anisotropy and thus, when, for example, a sheet is filled with the particles, a direction in which the thermal conductivity is reduced is generated.

In order to improve such a thermal anisotropy, for example, Patent Literature 1 proposes hexagonal boron nitride powder containing hexagonal boron nitride aggregates.

### CITATION LIST

### Patent Literature

[Patent Literature 1]
Japanese Patent Application Publication Tokukai No. 2011-98882

### SUMMARY OF INVENTION

### Technical Problem

Such conventional hexagonal boron nitride powder as disclosed in Patent Literature 1 has a tendency of further improving its thermal conductivity with a higher density in a filling state, since heat is transmitted via contact portions between the aggregated particles contained. Therefore, in order to exhibit a high thermal conductivity, a filling amount of the hexagonal boron nitride powder per unit volume tends to be large.

It is an object of an aspect of the present invention to achieve hexagonal boron nitride powder and the like that can exhibit a more favorable thermal conductivity with a smaller filling amount than conventional art.

### Solution to Problem

In order to attain the object, hexagonal boron nitride powder in accordance with an aspect of the present invention has a tap bulk density of not less than 0.50 g/cm³ and has an average particle diameter of not less than 15 μm, a ratio of the tap bulk density to a loose bulk density of the hexagonal boron nitride powder being not less than 2.1.

### Advantageous Effects of Invention

An aspect of the present invention makes it possible to achieve hexagonal boron nitride powder and the like that can exhibit a more favorable thermal conductivity with a smaller filling amount than conventional art.

### BRIEF DESCRIPTION OF DRAWINGS

FIG. 1 is a view schematically illustrating an overview of hexagonal boron nitride powder. The reference numeral 101 of FIG. 1 indicates a view illustrating a conventional example, and the reference numeral 102 of FIG. 1 indicates a view illustrating one example of the present invention.

### DESCRIPTION OF EMBODIMENTS

The following description will discuss an embodiment of the present invention in detail. Note that the expression “A to B” representing a numerical range herein means “not less than A and not more than B” unless otherwise specified in this specification.

### <Hexagonal Boron Nitride Powder>

Hexagonal boron nitride powder in accordance with an embodiment of the present invention (which may be hereinafter referred to as “present hexagonal boron nitride powder”) has a tap bulk density of not less than 0.50 g/cm³ and an average particle diameter of not less than 15 μm, a ratio of the tap bulk density to a loose bulk density thereof being not less than 2.1.

Hexagonal boron nitride forms primary particles each having a scale-like shape derived from its crystal structure. For example, in a case where resin is filled with the primary particles to form a resin sheet, the primary particles are oriented in a surface direction of the resin sheet. Thus, the thermal conductivity of the resin sheet in a thickness direction is reduced. In order to improve such a thermal anisotropy, hexagonal boron nitride powder containing aggregated particles made of hexagonal boron nitride has been proposed. The aggregated particles made of hexagonal boron nitride can each have a shape closer to a sphere than that of the primary particle, and thus can reduce the problem related to the thermal anisotropy.

The hexagonal boron nitride powder is, for example, used for a filler for resin for providing a resin composition, as a heat dissipation material. The thermal conductivity of such a resin composition tends to be increased with a higher filling density of the hexagonal boron nitride powder.

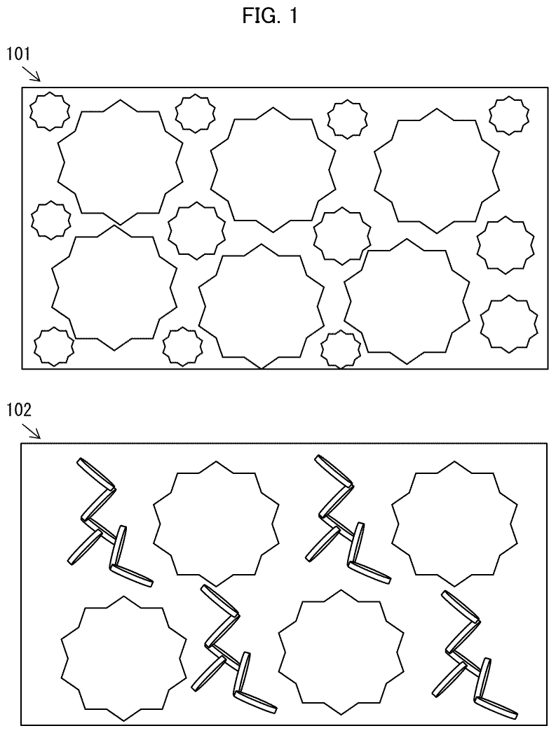

As shown in the reference example indicated by the reference numeral 101 in FIG. 1, the conventional hexagonal boron nitride powder can provide an improved filling density by containing two or more types of aggregated particles having different particle diameters. This is because the filling density can be easily enhanced by penetration of a small aggregated particle into a gap between aggregated particles having relatively large particle diameters.

However, when the filling density of the hexagonal boron nitride powder is increased in order to provide a desired thermal conductivity, an amount in which the hexagonal boron nitride powder is needed becomes larger accordingly. There is thus room for improvement from a viewpoint of the cost. In this regard, the present hexagonal boron nitride powder can provide a thermal conductivity equivalent to that of the conventional hexagonal boron nitride powder with a smaller filling amount than the conventional art. The following will describe the present hexagonal boron nitride powder.

### (Filling Density)

In the present hexagonal boron nitride powder, a ratio of a tap bulk density thereof to a loose bulk density thereof (tap bulk density/loose bulk density; which may be hereinafter referred to as “density ratio”) is not less than 2.1. The loose bulk density refers to a filling density of the powder in a rough filling state in which a container is loosely filled with the powder. The tap bulk density refers to a filling density of the powder in a dense filling state in which a container filled with the powder has become dense by being tapped predetermined times.

The tap bulk density of the present hexagonal boron nitride powder can be obtained with use of, for example, Tap Denser KYT-5000 available from SEISHIN ENTERPRISE CO., LTD. under the measurement conditions described later in Examples. The loose bulk density of the present hexagonal boron nitride powder can be obtained by measuring a filling density in a state in which a container is roughly filled with the powder before the tap for measuring the tap bulk density. The filling density of the present hexagonal boron nitride powder in the container is calculated by mass/volume thereof.

The filling density of the present hexagonal boron nitride powder having the density ratio as describe above is increased significantly by the tap. This, although not a particular limitation on the mechanism of action, indicates that the present hexagonal boron nitride powder has, for example, a complicated aggregation structure or the surface irregularities, so that the particles can be present in a state in a rough contact with each other to an extent that allows the filling density to be significantly increased by the tap. In such a rough connection state, the present hexagonal boron nitride powder can achieve a favorable thermal conductivity in the filled material, since heat is transmitted between the particles through contact between the particles.

The present hexagonal boron nitride powder having such a density ratio provides, when having an average particle diameter of not less than 15 μm, a favorable thermal conductivity, even if having a relatively low filling density, i.e., the tap bulk density of not less than 0.50 g/cm³. The present hexagonal boron nitride powder can provide a thermal conductivity equivalent to that of the conventional hexagonal boron nitride powder with a smaller filling density than the conventional art.

The present hexagonal boron nitride powder only needs to exhibit a density ratio of not less than 2.1, preferably, exhibits a density ratio of not less than 2.2, in order to provide a favorable thermal conductivity with a relatively low filling density. The density ratio may be not more than 4.0 or may be not more than 3.5.

The present hexagonal boron nitride powder preferably has a loose bulk density of 0.15 g/cm³ to 0.35 g/cm³. When the present hexagonal boron nitride powder has such a loose bulk density, the tap bulk density can be adjusted to a relatively small value with a density ratio of not less than 2.1. Therefore, the filling amount of the present hexagonal boron nitride powder can be reduced.

### (Average Particle Diameter)

The present hexagonal boron nitride powder only needs to have an average particle diameter of not less than 15 μm, and may have an average particle diameter of not less than 20 μm or not less than 25 μm, in order to improve a thermal conductivity thereof. The average particle diameter may be not more than 100 μm, not more than 75 μm, or not more than 50 μm in order to improve the fluidity.

### (First Aggregated Particle and Second Aggregated Particle)

The present hexagonal boron nitride powder satisfying the parameters as described above preferably contains at least two types of aggregated particles, e.g., a first aggregated particle and a second aggregated particle having a particle diameter different from that of the first aggregated particle. Both the first aggregated particle and the second aggregated particle are aggregated particles of primary hexagonal boron nitride particles.

The first aggregated particle refers to an aggregated particle having a particle diameter of 20 μm to 50 μm in the present hexagonal boron nitride powder. The first aggregated particle preferably has an average area circularity of not less than 0.1 and less than 0.6 and an average area solidity of not less than 0.4 and less than 0.9.

The area circularity becomes closer to 1.0 when the aggregated particle has a shape closer to a perfect sphere. Therefore, the first aggregated particle having the average area circularity as described above can be said to be an aggregated particle having a distorted shape different than the sphere. The area circularity of the aggregated particle is calculated with use of a two-dimensional projection image of the aggregated particle by “4π×projection area/(perimeter length)²”.

The area solidity becomes closer to 1.0 when the aggregated particle has a smoother contour. The first aggregated particle having the average area solidity as described above can be said to be an aggregated particle having a distorted shape with a rough contour. The area solidity of the aggregated particle can be calculated with use of a two-dimensional projection image of the aggregated particle by “area along an actual perimeter length/area along an enveloping perimeter length”.

Such a first aggregated particle having a distorted shape may have, for example, a branching shape like connected aggregated particles having spherical shapes. Such a first aggregated particle is likely brought into contact with another aggregated particle even with a low filling density. The shape of the first aggregated particle described above contributes to an improved thermal conductivity, since heat is efficiently transferred between the aggregated particles by contact between the aggregated particles. The present hexagonal boron nitride powder having the configuration described above thus can exhibit a high thermal conductivity even with a relatively low tap bulk density and can reduce an amount of the present hexagonal boron nitride powder used for filling.

The first aggregated particle may have an average area circularity of not less than 0.1 or not less than 0.2. The average area circularity may be less than 0.6, not more than 0.5, or not more than 0.4.

The first aggregated particle may have an average area solidity of not less than 0.4 or not less than 0.5. The average area solidity may be less than 0.9, not more than 0.8, or not more than 0.7.

The ratio of the first aggregated particle to the entire present hexagonal boron nitride powder may be not less than 20% by volume, not less than 25% by volume, or not less than 30% by volume. The ratio of the first aggregated particle may be not more than 70% by volume, not more than 65% by volume, or not more than 60% by volume. When containing the first aggregated particle in such a ratio, the present hexagonal boron nitride powder likely exhibits the density ratio described above.

The second aggregated particle refers to an aggregated particle having a particle diameter of 60 μm to 110 μm in the present hexagonal boron nitride powder. The second aggregated particle preferably has an average area circularity of 0.4 to 0.9 and an average area solidity of 0.4 to 0.9.

The second aggregated particle having such a configuration is an aggregated particle having a smooth shape closer to a sphere compared with the first aggregated particle. The first aggregated particles are efficiently positioned in spaces between such second aggregated particles and they are in contact with each other, in the filling state after the tap of the present hexagonal boron nitride powder, so that the thermal conductivity can be improved.

The ratio of the second aggregated particle to the entire present hexagonal boron nitride powder may be not less than 20% by volume, not less than 25% by volume, or not less than 30% by volume. The ratio of the second aggregated particle may be not more than 70% by volume, not more than 65% by volume, or not more than 60% by volume. When containing the second aggregated particle in such a ratio, the present hexagonal boron nitride powder likely has an improved thermal conductivity in a filling state.

The present hexagonal boron nitride powder may further contain an aggregated particle other than the first aggregated particle or the second aggregated particle, and may contain a primary particle that has not been aggregated. The present hexagonal boron nitride powder preferably contains the primary particle that has not been aggregated, in an amount of not more than 20% by volume.

The above configuration makes it possible to, even when there are gaps between the aggregated particles, increase the contact portions, while securing the gaps, between the first aggregated particles each having a distorted shape and the second aggregated particles that are larger than the first aggregated particles, as shown in the example of the present invention indicated by the reference numeral 102 of FIG. 1. Therefore, the desired thermal conductivity can be ensured with a smaller filling amount than conventional art in a filled material such as a resin composition, and an amount of the present hexagonal boron nitride powder used in producing the resin composition and the like can be reduced. This effect also contributes, for example, to achieving goal 12 “Ensure sustainable consumption and production patterns”, and the like of the Sustainable Development Goals (SDGs) established by the United Nations.

### <Method for Producing Hexagonal Boron Nitride Powder>

The present hexagonal boron nitride powder can be produced by, for example, the following method, although the production method is not particularly limited.

First, an oxygen-containing boron compound, a carbon source, an oxygen-containing calcium compound, and boron carbide are mixed in the ratio described below to obtain a mixture. The ratio B/C (element ratio) between a mass of the oxygen-containing boron compound in terms of B and a mass of the carbon source in terms of C is set to 0.75 to 1.05. The oxygen-containing calcium compound is set to an amount of 5 to 20 parts by mass in terms of CaO to a total amount of 100 parts by mass of a mass of the oxygen-containing boron compound in terms of B₂O₃ and a mass of the carbon source in terms of C. The boron carbide is set to an amount of 5 to 45 parts by mass to a total amount of 100 parts by mass of masses of the oxygen-containing boron compound, the carbon source, and the oxygen-containing calcium compound in terms of B₂O₃, C, and CaO, respectively.

Subsequently, the mixture thus obtained is heated under a nitrogen atmosphere to a temperature of 1600° C. to 1950° C., and a reduction nitridation reaction is carried out. The particle diameter distribution of the hexagonal boron nitride powder thus obtained is adjusted by disintegration. The byproduct other than boron nitride present in the product from the reduction nitridation reaction may be removed by acid washing. The hexagonal boron nitride powder after the acid washing is re-fired by heating the powder to a temperature of 1700° C. to 2050° C. under a gas atmosphere containing nitrogen.

As described above, the use of the two types of boron sources: the oxygen-containing boron compound and the boron carbide as raw materials provides the present hexagonal boron nitride powder containing the first aggregated particle and the second aggregated particle. Specifically, the oxygen-containing boron compound, the carbon source, and the oxygen-containing calcium compound presumably serve as the sources for generation of the first aggregated particle, and the boron carbide presumably serves as the core of the second aggregated particle.

### (Raw Materials)

As the oxygen-containing boron compound, a compound containing boron and an oxygen atom may be used. Examples of the oxygen-containing boron compound include boric acid, boric acid anhydride, metaboric acid, perboric acid, hypoboric acid, sodium tetraborate, and sodium perborate. Among these, boric acid or boron oxide, which are easily available, may be preferably used.

The oxygen-containing calcium compound plays a role in forming a complex oxide with the oxygen-containing boron compound to form a complex oxide having a high melting point and thus preventing the oxygen-containing boron compound from being volatilized. It has also been confirmed that it plays a role as a catalyst in a reaction that directly nitrides boron carbide.

Examples of the oxygen-containing calcium compound include calcium carbonate, calcium hydrogen carbonate, calcium hydroxide, calcium oxide, calcium nitrate, calcium sulfate, calcium phosphate, and calcium oxalate. It is possible to use one type or two or more types of these mixed together. Among them, it is preferable to use calcium oxide or calcium carbonate.

Examples of the carbon source include crystalline carbons such as diamond, graphite, and nanocarbon; and pyrolytic carbons obtained by pyrolysis of monomers or polymers, in addition to amorphous carbons such as carbon black, activated carbon, and carbon fiber. Among them, the amorphous carbons, which are highly reactive, are preferable, and the carbon black is particularly suitably used, since its quality is industrially controlled. Examples of the carbon black include acetylene black, furnace black, and thermal black.

As boron carbide, a known carbon boron may be used. The particle diameter of the boron carbide is preferably 1 to 500 μm, further preferably, 10 to 400 μm, still further preferably, 20 to 300 μm.

The mixture containing the raw materials may be supplied to the reduction nitridation reaction, for example, in the form of powder as it is or in the form of granulated products formed therefrom. The mixing of the raw materials can be carried out, for example, with use of a mixer such as a vibrating mill, a bead mill, a ball mill, a Henschel mixer, a drum mixer, a vibrating shaker, or a V-shaped mixer.

### (Reduction Nitridation)

In the reduction nitridation reaction, a nitrogen source can be supplied to the reaction system by a known means. The most preferable method is, for example, to cause nitrogen gas to flow into the reaction system of the reaction device, an example of which will be shown later. The nitrogen source used is not limited to nitrogen gas, and is not particularly limited, provided that it is a gas capable of being nitrided in a reduction nitridation reaction. Specifically, ammonia gas can be used, as well as the nitrogen gas. It is also possible to use the nitrogen gas or ammonia gas mixed with a non-oxidizing gas, such as hydrogen, argon, and helium.

In order to provide a hexagonal boron nitride powder having a high crystallinity, a temperature of 1600° C. to 1950° C., preferably 1650° C. to 1900° C., further preferably 1680° C. to 1880° C. can be employed as a heating temperature in the reduction nitridation reaction. That is, when the heating temperature is less than 1600° C., the reduction nitridation reaction has not progressed and it is difficult to provide a hexagonal boron nitride having a high crystallinity, and when the heating temperature exceeds 1950° C., the effect has reached the peak and is economically disadvantageous.

The time for the reduction nitridation reaction is determined as appropriate, but it is, for example, approximately 10 to 30 hours.

### (Particle Diameter Adjustment)

The hexagonal boron nitride powder after the reduction nitridation reaction may be adjusted to have a predetermined particle diameter distribution by carrying out disintegration. The disintegration is preferably carried out gently with use of, for example, a jet mill, a ball mill, a hammer mill, or a stone mill type pulverizer. The particle diameter of the powder after the disintegration may be adjusted as appropriate by a classification treatment through air classification or sieve treatment.

After disintegration and before re-firing, the volume frequency of aggregated particles having particle diameters of not more than 10 μm and the volume frequency of aggregated particles having particle diameters of more than 10 μm and not more than 50 μm in the hexagonal boron nitride powder are preferably adjusted to fall within predetermined ranges.

Specifically, the volume frequency of the aggregated particles having particle diameters of not more than 10 μm is preferably set to less than 10%, further preferably set to not more than 7%, still further preferably set to not more than 5%. No aggregated particle having a particle diameter of not more than 10 μm may be contained in the hexagonal boron nitride powder before re-firing.

The volume frequency of the aggregated particles having particle diameters of more than 10 μm and not more than 50 μm may be not less than 20%, preferably is not less than 25%, more preferably, is not less than 30%. The volume frequency of the aggregated particles having particle diameters of more than 10 μm and not more than 50 μm may be not more than 65%, preferably is not more than 60%.

Adjusting the hexagonal boron nitride powder before re-firing to have the particle diameter distribution as described above makes it possible to suitably provide the present hexagonal boron nitride powder exhibiting a density ratio of not less than 2.1 after re-firing.

### (Acid Washing)

The reaction product obtained by the above-described reduction nitridation reaction contains impurities such as a complex oxide composed of boron oxide-calcium oxide in addition to the hexagonal boron nitride powder, and thus is preferably washed with use of acid. A method for the acid washing is not particularly limited, and a known method may be employed without limitation. For example, one possible method is as follows. Byproduct-containing boron nitride powder obtained after the reduction nitridation reaction is introduced into a container, and dilute hydrochloric acid (10 to 20% HCl by mass) in an amount 5 to 10 times that of the byproduct-containing boron nitride powder is added to the container to bring them into contact for 4 hours to 8 hours.

The acid used in the acid washing can be, for example, nitric acid, sulfuric acid, or acetic acid, as well as the hydrochloric acid.

After the acid washing, water washing using pure water may be carried out in order to wash the remaining acid away. The method for the water washing may involve filtering out the acid used in the acid washing, then dispersing, in the same amount of pure water as that of the acid used, the hexagonal boron nitride powder that has been subjected to the acid washing, and carrying out filtering again.

### (Drying)

Water-containing agglomerates may be dried after the acid washing or water washing. The drying is preferably carried out under a condition, e.g., in an atmosphere of 50° C. to 250° C. or under reduced pressure. The drying time is not particularly specified, but the drying is preferably carried out until the water content becomes closer to 0% as much as possible.

### (Re-Firing)

The gas atmosphere containing nitrogen under which the re-firing is carried out may be, for example, an atmosphere containing nitrogen. The supplying of the nitrogen source to the reaction system in the re-firing may be the same method as that of reduction nitridation.

As a heating temperature in the re-firing, a temperature of 1700° C. to 2050° C., preferably 1800° C. to 2000° C., further preferably 1900° C. to 2000° C. can be employed. Such a heating temperature can suitably provide the present hexagonal boron nitride powder exhibiting a density ratio of not less than 2.1.

The reduction nitridation reaction and re-firing described above can be carried out with use of a known reaction device capable of controlling a reaction atmosphere. For example, one possible option is an atmosphere control-type high-temperature furnace in which heating treatment is performed by high-frequency induction heating or by heating with a heater, and a continuous heating furnace such as a pusher-type tunnel furnace and a vertical reaction furnace can be used as well as a batch furnace.

### <Resin Composition>

The present hexagonal boron nitride powder can be, for example, used as a filler for a resin composition. That is, a resin composition in accordance with an embodiment of the present invention (which may be hereinafter referred to as “present resin composition”) may contain the present hexagonal boron nitride powder. In the present resin composition, the present hexagonal boron nitride powder may be used as a filler to be mixed with the resin described later in order to, for example, improve an electrical insulation property or impart a thermal conduction property. The present resin composition has a high electrical insulation property and thermal conduction property by being filled with the present hexagonal boron nitride powder.

The present resin composition can be used for various applications. The present resin composition may be preferably used, by forming a thermally conductive resin composition or a thermally conductive molded product, for applications, e.g., thermal interface materials such as a polymer-based heat dissipation sheet and a phase change sheet; organic heat dissipation sheets such as a heat dissipation tape, a heat dissipation grease, a heat dissipation adhesive, and a gap filler; heat dissipation paints such as a heat dissipation paint and a heat dissipation coating; heat dissipation resin substrates such as a PWB-based resin substrate and a CCL-based resin substrate; insulating layers for metal-based substrates such as an aluminum-based substrate and a copper-based substrate; and sealing materials for power devices.

The present resin composition may contain a thermally conductive filler, such as aluminum nitride and aluminum oxide, which are known highly thermally conductive insulating fillers.

Examples of the resin include thermoplastic resins such as polyolefin, vinyl chloride resin, methyl methacrylate resin, nylon, and fluorine resin; thermosetting resins such as epoxy resin, phenolic resin, urea resin, melamine resin, unsaturated polyester resin, silicon resin, and bismaleimide triazine resin; and synthetic rubbers.

The present resin composition may further contain, for example, a polymerization initiator, a curing agent, a polymerization inhibitor, a polymerization retardant, a coupling agent, a plasticizer, an ultraviolet light absorber, a pigment, a colorant, an antibacterial agent, an organic filler, and an organic/inorganic composite filler which are known as compounding agents for the resin composition, according to need. The present resin composition may also contain other inorganic fillers to an extent that does not impair the effects of the present invention.

### <Resin Sheet>

A resin sheet in accordance with an embodiment of the present invention (which may be hereinafter referred to as “present resin sheet”) may be composed of the present resin composition described above. The present resin sheet has applications that are not particularly limited, but can be used for applications, e.g., a circuit substrate, an insulating layer of a multi-layer printed wiring board, and the like.

### Other Applications

The present hexagonal boron nitride powder can also be used for applications, e.g., raw materials for boron nitride processing products such as a cubic boron nitride or boron nitride molded product; nuclear agents for engineering plastics; phase change materials; solid or liquid thermal interface materials; mold releasing agents for molten metal molds or molten glass molds; cosmetics; and composite ceramic raw materials.

Aspects of the present invention can also be expressed as follows:

As described above, hexagonal boron nitride powder in accordance with Aspect 1 of the present invention has a tap bulk density of not less than 0.50 g/cm³ and has an average particle diameter of not less than 15 μm, a ratio of the tap bulk density to a loose bulk density of the hexagonal boron nitride powder being not less than 2.1.

Hexagonal boron nitride powder in accordance with Aspect 2 of the present invention may be configured, in Aspect 1 above, to contain first aggregated particles that are aggregated particles of primary hexagonal boron nitride particles and that have a particle diameter of 20 μm to 50 μm, the first aggregated particles having an average area circularity of not less than 0.1 and less than 0.6 and having an average area solidity of not less than 0.4 and less than 0.9.

Hexagonal boron nitride powder in accordance with Aspect 3 of the present invention may be configured, in Aspect 2 above, to further contain second aggregated particles that are aggregated particles of primary hexagonal boron nitride particles and that have a particle diameter of 60 μm to 110 μm, the second aggregated particles having an average area circularity of 0.4 to 0.9 and having an average area solidity of 0.4 to 0.9.

Hexagonal boron nitride powder in accordance with Aspect 4 of the present invention may be configured, in any one of Aspects 1 to 3 above, such that the loose bulk density is 0.15 g/cm³ to 0.35 g/cm³.

A resin composition in accordance with Aspect 5 of the present invention contains the hexagonal boron nitride powder in accordance with any one of Aspects 1 to 4.

A resin sheet in accordance with Aspect 6 of the present invention is composed of the resin composition in accordance with Aspect 5 above.

### EXAMPLES

The following description will discuss an example of the present invention, but the present invention is not limited to Examples described later.

### <Production and Evaluation of Hexagonal Boron Nitride Powder>

Hexagonal boron nitride powders in accordance with Examples and Comparative Examples were produced by the following methods.

### Example 1

With respect to hexagonal boron nitride powder in accordance with Example 1, 259 g of a mixture containing 141 g of boron oxide, 56 g of carbon black, 32 g of calcium oxide and 30 g of boron carbide was mixed with use of a ball mill. The mixture was subjected to a reduction nitridation treatment by retaining the mixture with use of a graphite Tammann furnace for 2 hours at a maximum temperature of 1750° C. under a nitrogen gas atmosphere.

The hexagonal boron nitride thus obtained was subjected to disintegration, so that in the particle diameter distribution thereof, the volume-based ratio of aggregated particles of not more than 10 μm was adjusted to 4%, and the volume-based ratio of aggregated particles of more than 10 μm and not more than 50 μm was adjusted to 48%. The hexagonal boron nitride powder after the adjustment of the particle diameter distribution was introduced into a container, and hydrochloric acid (7% HCl by mass) in an amount 5 times that of the hexagonal boron nitride powder was added to the container. An acid washing treatment was then carried out by stirring at a rotation speed of 700 rpm for 24 hours. After the acid washing treatment, the acid was filtered out. The hexagonal boron nitride powder thus obtained after the filtering was then dispersed in the same amount of pure water as that of the acid used, and filtering was carried out again. This procedure was repeated 5 times, and then drying was carried out in vacuum at 200° C. for 6 hours.

A re-firing treatment was carried out on hexagonal boron nitride powder obtained after the drying, by retaining the hexagonal boron nitride powder with use of a graphite Tammann furnace for 6 hours at 1900° C. under a nitrogen gas atmosphere.

The hexagonal boron nitride powder obtained after the re-firing was sieved with use of a sieve having a mesh size of 106 μm to obtain white hexagonal boron nitride powder.

### Example 2

The hexagonal boron nitride powder in accordance with Example 2 was produced under the conditions as in Example 1 other than the disintegration condition. The particle diameter distribution after the disintegration was adjusted such that the volume-based ratio of the aggregated particles of not more than 10 μm was 2%, and the volume-based ratio of the aggregated particles of more than 10 μm and not more than 50 μm was 25%.

### Example 3

The hexagonal boron nitride powder in accordance with Example 3 was produced under the conditions as in Example 1 other than the disintegration condition. The particle diameter distribution after the disintegration was adjusted such that the volume-based ratio of the aggregated particles of not more than 10 μm was 5%, and the volume-based ratio of the aggregated particles of more than 10 μm and not more than 50 μm was 58%.

### Example 4

The hexagonal boron nitride powder in accordance with Example 4 was produced under the conditions as in Example 1 other than the disintegration condition. The particle diameter distribution after the disintegration was adjusted such that the volume-based ratio of the aggregated particles of not more than 10 μm was 4%, and the volume-based ratio of the aggregated particles of more than 10 μm and not more than 50 μm was 45%.

### Example 5

The hexagonal boron nitride powder in accordance with Example 5 was produced under the conditions as in Example 1 other than the disintegration condition. The particle diameter distribution after the disintegration was adjusted such that the volume-based ratio of the aggregated particles of not more than 10 μm was 3%, and the volume-based ratio of the aggregated particles of more than 10 μm and not more than 50 μm was 42%.

### Example 6

The hexagonal boron nitride powder in accordance with Example 6 was produced under the conditions as in Example 1 other than the disintegration condition. The particle diameter distribution after the disintegration was adjusted such that the volume-based ratio of the aggregated particles of not more than 10 μm was 3%, and the volume-based ratio of the aggregated particles of more than 10 μm and not more than 50 μm was 30%.

### Comparative Example 1

The hexagonal boron nitride powder in accordance with Comparative Example 1 was produced under the conditions as in Example 1 other than the disintegration condition. The particle diameter distribution after the disintegration was adjusted such that the volume-based ratio of the aggregated particles of not more than 10 μm was 10%, and the volume-based ratio of the aggregated particles of more than 10 μm and not more than 50 μm was 30%.

### Comparative Example 2

With respect to hexagonal boron nitride powder in accordance with Comparative Example 2, 242 g of a mixture containing 142 g of boron oxide, 62 g of carbon black, and 38 g of calcium oxide without the boron carbide as a raw material was subjected to a reduction nitridation treatment. Except in this regard, it was produced under the conditions as in Example 1. The particle diameter distribution after the disintegration was adjusted such that the volume-based ratio of the aggregated particles of not more than 10 μm was 30%, and the volume-based ratio of the aggregated particles of more than 10 μm and not more than 50 μm was 70%.

### Comparative Example 3

Hexagonal boron nitride powder in accordance with Comparative Example 3 was produced under the conditions as in Example 1 except that the heating temperature in the re-firing was set to 1500° C. The particle diameter distribution after the disintegration was adjusted such that the volume-based ratio of the aggregated particles of not more than 10 μm was 4%, and the volume-based ratio of the aggregated particles of more than 10 μm and not more than 50 μm was 40%.

### Comparative Example 4

The hexagonal boron nitride powder in accordance with Comparative Example 4 was produced under the conditions as in Comparative Example 3 other than the disintegration condition. The particle diameter distribution after the disintegration was adjusted such that the volume-based ratio of the aggregated particles of not more than 10 μm was 2%, and the volume-based ratio of the aggregated particles of more than 10 μm and not more than 50 μm was 20%.

The presence or absence of boron carbide (B₄C), the particle diameter distribution of the hexagonal boron nitride powder before the re-firing, and the heating temperature (maximum temperature reached) for the re-firing are listed in Table 1 below. The tap bulk density, loose bulk density, density ratio (tap bulk density/loose bulk density), and average particle diameter of the hexagonal boron nitride powder thus obtained after the re-firing are also shown in Table 1 below. Note that “10 to 50 μm” present in the column showing the particle diameter distribution before the re-firing in Table 1 indicates more than 10 μm and not more than 50 μm.

TABLE 1

| | Production condition | | | | | | | |
|---|---|---|---|---|---|---|---|---|
| | | Pre re-firing particle | | | | | | |
| | | diameter distribution | | | Hexagonal boron nitride powder after re-firing | | | |
| | Reduction | Not more | | Re-firing | | Loose | | Average |
| | nitridation | than 10 μm | 10 to 50 μm | maximum | Tap bulk | bulk | Density | diameter |
| | raw material | volume- | volume- | temperature | density | density | ratio | particle |
| | B₄C | based % | based % | ° C. | g/cm³ | g/cm³ | — | μm |
| Example 1 | Contained | 4 | 48 | 1900 | 0.62 | 0.22 | 2.82 | 30 |
| Example 2 | Contained | 2 | 25 | 1900 | 0.78 | 0.26 | 3.00 | 50 |
| Example 3 | Contained | 5 | 58 | 1900 | 0.65 | 0.29 | 2.24 | 25 |
| Example 4 | Contained | 4 | 45 | 1900 | 0.52 | 0.22 | 2.36 | 40 |
| Example 5 | Contained | 3 | 42 | 1900 | 0.62 | 0.16 | 3.88 | 35 |
| Example 6 | Contained | 3 | 30 | 1900 | 0.80 | 0.33 | 2.42 | 45 |
| Comparative | Contained | 10 | 30 | 1900 | 0.83 | 0.42 | 1.98 | 45 |
| Example 1 | | | | | | | | |
| Comparative | Not contained | 30 | 70 | 1900 | 0.49 | 0.27 | 1.81 | 10 |
| Example 2 | | | | | | | | |
| Comparative | Contained | 4 | 40 | 1500 | 0.65 | 0.33 | 1.97 | 30 |
| Example 3 | | | | | | | | |
| Comparative | Contained | 2 | 20 | 1500 | 0.78 | 0.40 | 1.95 | 55 |
| Example 4 | | | | | | | | |

### (Evaluation Method)

### Loose Bulk Density and Tap Bulk Density

The loose bulk density and the tap bulk density of the hexagonal boron nitride powder were measured with use of Tap Denser KYT-5000 available from SEISHIN ENTERPRISE CO., LTD. A 100-mL sample cell was roughly filled with the hexagonal boron nitride powder, and a loose bulk density was calculated from its mass and volume immediately after the rough filling. Next, the 100-mL sample cell after the calculation of the loose bulk density was tapped under conditions of a tap speed of 120 times/min, a tap height of 5 cm, and a number of times of the tap of 500 times, and the tap bulk density was calculated from the mass and volume after the tap. The sample cell is composed of a capped cylinder having a diameter of 28 mm and a height of 163 mm.

### Average Area Circularity, Average Area Solidity, and Volume Ratio

The hexagonal boron nitride powder was evaluated as for the average particle diameter of the entire hexagonal boron nitride powder; and average area circularities, average area solidities, and volume ratios of the first aggregated particle and the second aggregated particle with use of Morphologi G3-ID/G3SE-ID available from Malvern.

Average Particle Diameter, Volume-Based % of Ones of not More than 10 μm and Volume Based % of Ones of More than 10 μm and not More than 50 μm

The hexagonal boron nitride powder was measured as for an average particle diameter (μm) thereof, a volume-based percentage of ones of not more than 10 μm, and a volume-based percentage of ones of more than 10 μm and not more than 50 μm with use of the laser diffraction/scattering type particle diameter measurement device MT3000 (available from MicrotracBEL Corp.). Specifically, a sample obtained by introducing 0.1 g of hexagonal boron nitride powder into a mixing vessel attached to the device filled with 50 cc of ethanol was used for the measurement, and a volume-based particle diameter (D50), a volume-based percentage of ones of not more than 10 μm, and a volume-based percentage of ones of more than 10 μm and not more than 50 μm were calculated from the measurement results. In this case, the measurement was carried out without a disintegration treatment or the like such as an ultrasonic treatment.

### Results

The results of evaluating the first aggregated particles and the second aggregated particles of the hexagonal boron nitride powders in accordance with Examples and Comparative Examples are shown in Table 2 below.

TABLE 2

| | First aggregated particle | | | Second aggregated particle | | |
|---|---|---|---|---|---|---|
| | Average | | | Average | | |
| | area | Average | | area | Average | |
| | circu- | area | % by | circu- | area | % by |
| | larity | solidity | volume | larity | solidity | volume |
| Example 1 | 0.2 | 0.6 | 54 | 0.5 | 0.9 | 35 |
| Example 2 | 0.3 | 0.5 | 34 | 0.5 | 0.9 | 55 |
| Example 3 | 0.3 | 0.7 | 54 | 0.5 | 0.8 | 39 |
| Example 4 | 0.3 | 0.5 | 43 | 0.6 | 0.95 | 50 |
| Example 5 | 0.2 | 0.5 | 52 | 0.5 | 0.8 | 40 |
| Example 6 | 0.3 | 0.7 | 51 | 0.6 | 0.8 | 44 |
| Comparative | 0.7 | 0.9 | 49 | 0.6 | 0.8 | 45 |
| Example 1 | | | | | | |
| Comparative | — | — | 90 | — | — | 0 |
| Example 2 | | | | | | |
| Comparative | 0.6 | 0.9 | 53 | 0.5 | 0.8 | 33 |
| Example 3 | | | | | | |
| Comparative | 0.7 | 0.9 | 40 | 0.6 | 0.95 | 60 |
| Example 4 | | | | | | |

In each of the hexagonal boron nitride powders in accordance with Examples 1 to 6, the first aggregated particle had an average area circularity of 0.2 to 0.3 and an average area solidity of 0.5 to 0.7. This result indicates that the first aggregated particle had a distorted shape.

In contrast, the first aggregated particle in accordance with each of Comparative Examples 1, 3, and 4 had an average area circularity of not less than 0.6 and an average area solidity of not less than 0.8. That is, the first aggregated particles in accordance with Comparative Examples 1, 3, and 4 each had a shape closer to a sphere than the first aggregated particles in accordance with Examples.

The hexagonal boron nitride powders in accordance with Examples 1 to 6 and Comparative Examples 1, 3, and 4 each contained second aggregated particles having shapes closer to a sphere than the first aggregated particles in accordance with Examples. The first aggregated particles having particle diameters of 20 μm to 50 μm accounted for most of the hexagonal boron nitride powder in accordance with Comparative Example 2, and no second aggregated particle having a particle diameter of not less than 60 μm was detected in the hexagonal boron nitride powder. Therefore, the average area circularity and average area solidity thereof were not evaluated.

It was shown that in order to obtain the present hexagonal boron nitride powder, it is important to adjust the particle diameter distribution before the re-firing so that the volume-based ratio of the aggregated particles of not more than 10 μm is less than 10%, as indicated by Comparative Examples 1 and 2. As indicated by Comparative Examples 3 and 4, it was also shown that it is important to set the maximum temperature reached in the re-firing to not less than 1700° C.

<Evaluation of Resin Sheet Filled with Hexagonal Boron Nitride Powder>

Subsequently, resin sheets filled with hexagonal boron nitride powders in accordance with Examples and Comparative Examples were produced and were evaluated as for thermal conductivities thereof.

### (Method for Producing Resin Sheet)

Epoxy resin was filled with the hexagonal boron nitride powder thus obtained to prepare a resin composition, which was evaluated as for a thermal conductivity thereof. A mixture of 100 parts by mass of epoxy resin (JER828 available from Mitsubishi Chemical Corporation), 5 parts by mass of a curing agent (imidazole curing agent; CUREZOL 2E4MZ available from SHIKOKU CHEMICALS CORPORATION), and 210 parts by mass of methyl ethyl ketone as a solvent was prepared. Subsequently, a resin composition was obtained by mixing the mixture in the form of varnish and the hexagonal boron nitride powder with use of a planetary centrifugal mixer (MAZERUSTAR available from Kurabo Industries Ltd.) so that the base resin and the specific boron nitride powder respectively accounted for 35% by volume and 65% by volume, or the base resin and the specific boron nitride powder respectively accounted for 40% by volume and 60% by volume, or the base resin and the specific boron nitride powder respectively accounted for 45% by volume and 55% by volume.

The resin composition was coated on a PET film so as to have a thickness of approximately 180 to 220 μm with use of the automatic coating machine PI-1210 available from Tester Sangyo Co., Ltd. and was dried. The resin composition was then cured under a reduced pressure, under conditions of a temperature of 200° C., a pressure of 5 MPa, and a retention time of 30 minutes, so as to prepare a sheet with a thickness of 150 μm. The sheet was analyzed with use of a temperature wave heat analyzing device, and a thermal conductivity was calculated.

### Results

The thermal conductivities (W/m·K) of the resin sheets obtained are shown in Table 3 below.

TABLE 3

| | Filling | Filling | Filling |
|---|---|---|---|
| | amount | amount | amount |
| | 55 vol % | 60 vol % | 65 vol % |
| | W/m · K | W/m · K | W/m · K |
| Example 1 | 14 | 16 | 20 |
| Example 2 | 14 | 15 | 20 |
| Example 3 | 14 | 16 | 21 |
| Example 4 | 14 | 16 | 20 |
| Example 5 | 14 | 16 | 20 |
| Example 6 | 14 | 16 | 20 |
| Comparative | 11 | 14 | 20 |
| Example 1 | | | |
| Comparative | 8 | 10 | 12 |
| Example 2 | | | |
| Comparative | 12 | 14 | 19 |
| Example 3 | | | |
| Comparative | 11 | 14 | 20 |
| Example 4 | | | |

Under the conditions of the filling amounts of 55% by volume and 60% by volume, the resin sheets in accordance with Examples 1 to 6 exhibited higher thermal conductivities than those of the resin sheets in accordance with Comparative Examples 1 to 4. On the other hand, under the condition of the filling amount of 65% by volume, the thermal conductivities of the resin sheets in accordance with Examples and Comparative Examples were equivalent, except for Comparative Example 2. This result shows that the hexagonal boron nitride powder in accordance with an embodiment of the present invention is particularly effective for providing a higher thermal conductivity than conventional art in a range of a relatively low filling amount.

The above results showed that using hexagonal boron nitride powder in accordance with an embodiment of the present invention can further reduce the filling amount for providing a desired thermal conductivity than conventional art.

### ADDITIONAL REMARKS

The present invention is not limited to the description of the embodiments and examples above, but may be altered in various ways by a skilled person within the scope of the claims. Any embodiment based on a proper combination of technical means disclosed in different embodiments or Examples is encompassed in the technical scope of the present invention.

1. Hexagonal boron nitride powder having a tap bulk density of not less than 0.50 g/cm³ and having an average particle diameter of not less than 15 μm, a ratio of the tap bulk density to a loose bulk density of the hexagonal boron nitride powder being not less than 2.1.

2. The hexagonal boron nitride powder according to claim 1, comprising first aggregated particles that are aggregated particles of primary hexagonal boron nitride particles and that have a particle diameter of 20 μm to 50 μm,
the first aggregated particles having an average area circularity of not less than 0.1 and less than 0.6 and having an average area solidity of not less than 0.4 and less than 0.9.

3. The hexagonal boron nitride powder according to claim 2, further comprising second aggregated particles that are aggregated particles of primary hexagonal boron nitride particles and that have a particle diameter of 60 μm to 110 μm,
the second aggregated particles having an average area circularity of 0.4 to 0.9 and having an average area solidity of 0.4 to 0.9.

4. The hexagonal boron nitride powder according to claim 1, wherein the loose bulk density is 0.15 g/cm³ to 0.35 g/cm³.

5. A resin composition comprising the hexagonal boron nitride powder according to claim 1.

6. A resin sheet composed of the resin composition according to claim 5.
